(19) United States
(12) Patent Application Publication
(10) Pub. No.: US 2002/0028387 A1
(43) Pub. Date: Mar. 7, 2002

(54) Polymer gel electrolyte

(76) Inventors: Patrick Gavelin, Helsingborg (SE); Patric Jannasch, Lund (SE)

Correspondence Address: Stanley R. Moore, Esq., Jenkens and Gilchrist, P.C., 3200 Fountain Place, 1445 Ross Ave., Dallas, TX, 75202-2799, US

(21) Appl. No.: 09/745,119

(22) Filed: Dec. 20, 2000

(30) Foreign Application Priority Data
Dec. 20, 1999 (SE) 9904696-3

(51) Int. Cl. H01M 10/40

(52) U.S. Cl. 429/303; 429/317; 429/316

(57) ABSTRACT

A polymer gel electrolyte comprising a metal salt, a polymer, optionally a plasticizer, characterized in that the polymer comprises a carbon-hydrogen base chain having at least two reactive groups incorporated wherein the reactive groups have different reactivities. The polymer gel electrolyte neutralises a passivating layer in the form of waste products produced in the electrolyte phase by the metal salt and solvents. The decrease in the growth of the passivating layer provides a battery cell with a better effect and a longer life.

### TECHNICAL FILED OF THE INVENTION

The present invention relates to a polymer gel electrolyte, a battery cell comprising such an electrolyte, and use thereof. In particular, the invention relates to a polymer gel electrolyte for use in lithium ion batteries.

### BACKGROUND OF THE INVENTION

A battery is usually composed of a number of elementary units called electro-chemical cells. Each of these cells consist of a negative electrode, a positive electrode, and an electrolyte, in which the two electrodes are immersed, with or without the interposition of a separator. The most important function of the separator is to prevent electronic contact between different plates and absorb the electrolyte. Moreover, it is also important to keep the resistance as low as possible.

By the term “battery” is meant herein, a collection of two or more cells connected together with electrically conductive material, placed in a case.

There are two main types of batteries, primary batteries and secondary batteries; however in the following, only secondary batteries will be considered. Secondary batteries can be charged by a source of electrical energy, from which batteries the energy can be recovered. Secondary batteries are also called accumulators, or rechargeable batteries. The latter term will be used in the following.

Rechargeable batteries are often used as power supply in portable communication equipment, such as cellular phones, personal pagers, portable computers and other electrical devices, such as smart cards, calculators etc.

In a rechargeable battery, ions of a source electrode material move between electrodes through an intermediate electrolyte during the charge and discharge cycles of the cells. During discharge, the electricity-producing reactions cause reversible changes in the composition of the electrodes and the electrolyte. During charging, these changes can be reversed to the original conditions. The electrochemical reactions take place both at the negative electrode (which is the anode in the discharging mode and the cathode in the charging mode) and at the positive electrode of the electrochemical cell.

Lithium battery technology is a relatively new field and subject of intensive research. The main battery characteristics to be improved by new research are size, weight, energy density, capacity, lower discharge rates, cost and environmental safety. One major problem with lithium rechargeable batteries is related to the rechargeability of lithium, which reacts with the electrolyte forming a film. The film tends to electrically isolate the lithium from the substrate and makes the lithium less accessible to electro-stripping with each charge-discharge cycle because of accumulation of insulating films on the lithium electrode.

There are two main types of rechargeable lithium batteries, namely ambient temperature cells and elevated-temperature cells, the latter operating at an elevated temperature at about 450° C. (LiCl—KCl). The latter avoid the problem related to lithium rechargeability, by using a Li—Al- or Li—Si-anode and a metal sulphide cathode, normally FeS or FeS₂. However, these elevated-temperature cells require costly components because of extreme operating conditions, and are therefore less useable.

A particular type of ambient-temperature secondary non-aqueous system that has attracted attention in the past several years is the so-called “polymer battery”. Polyacetylene as well as polyphenylene have been used as polymer. In the undoped state theses polymers have relatively poor conductivity, but this increases by a factor of about 10¹², i.e. to metallic levels, with oxidative or reductive doping. Cathode doping and charging occurs simultaneously when for instance, a polyacetylene film is charged positively versus a Pt cathode.

Most attention has now been focused on lithium ion secondary batteries using a negative electrode comprising a host of a carbon material with inserted lithium ions. These systems utilize an intercalation and de-intercalation reaction of the lithium ions in the host. The lithium ion secondary battery generally has a lower theoretical negative electrode capacity than the lithium metal secondary battery, but is superior in cycle characteristic and system reliability. Frequently, lithium ion secondary battery cells employ organic electrolytic solutions as their electrolytes. However, the use of an organic liquid electrolyte imposes problems associated with the reliability of the battery system, e.g. leakage of the electrolyte out of the battery, vaporization of the solvent of the electrolyte, and dissolution of electrode material in the electrolytic solution. Since the electrolyte contains a flammable organic solvent, the leakage of the solvent may result in ignition. While better manufacturing techniques have decreased the occurrences of leakage, lithium ion secondary battery cells still can leak potentially dangerous electrolytes. Battery cells using liquid electrolytes are also not available for all designs and do not have sufficient flexibility)

For lithium batteries, polymer gel electrolytes have been in the main focus for the battery manufacturing so far. The advantage of gel electrolytes is that a high conductivity can be reached,>1 mS/cm, while a disadvantage is the poor compatibility with the anode. The reason for poor compatibility is the building up of a passivating layer on the surface of the anode. Earlier attempts to improve the stability of the polymer gel electrolyte towards the anode using additives have not been successful.

Gel electrolytes of today normally consist of an electrolyte solution dissolved in a polymer matrix. The polymer matrix is basically passive in relation to the ionic conduction process and the electrolyte components. The most successful published polymers are based on poly(methyl methacrylate) (PMMA) and copolymers of vinylidene fluoride (VDF) and hexafluoropropene (HFP) (Kynarflex®). There is no molecular interaction between these polymers and the electrolyte solution, and can be considered as basically two-phase systems.

U.S Pat. No. 5,587,253 discloses a lithium ion battery with an electrolyte/separator composition comprising a vinylidene fluoride copolymer and a plasticizer. The crystalline structure of the vinylidene fluoride copolymer necessitates the introduction of plasticizers to disrupt the crystalline regions of the copolymer matrix simulating an amorphous region that leads to higher ionic conductivity. In addition, the introduction of plasticizer reduces the glass transition temperature of the polymer, allowing it to undergo melt flow or softening during operation of the battery.

U.S Pat. No. 5,633,098 discloses batteries containing single-ion conducting solid polymer electrolytes. The polymers are polysiloxanes substituted with fluorinated poly(alkylene oxide) side chains having associated ionic species.

U.S Pat. No. 5,620,811 discloses a lithium polymer electrochemical battery. The battery comprises a first composite electrode, an electrolyte layer, and a second composite electrode. The composite electrode comprises at least one active material, a polymer or polymer blend for lending ionic conductivity and mechanical strength. The electrolyte may also comprise a polymer, as well as an electrolyte active material. The polymer from which the composite electrode is fabricated may also be the same or different than the polymer from which the electrolyte layer is fabricated.

U.S Pat. No. 5,407,593 teaches that the main path for ion transport in a polymer electrolyte is via the amorphous regions of a polymer matrix. Thus, decreasing the crystalline regions and increasing the amorphous regions of the polymer matrix may increase the ionic conductivity of a polymeric electrolyte. The methods frequently used to achieve this are: (1) preparing a new polymer such as a copolymer or polymer with a network structure; (2) adding non-soluble additives to improve the electrolytic property; and (3) adding soluble additives to provide a new path for ionic conductivity. Polymers having high dielectric constants are good matrices for preparing polymeric electrolytes. However, because they have high glass transition temperatures or high degrees of crystallinity, they do not give desirable polymeric electrolytes. To remedy this, this document discloses a polymeric electrolyte containing no volatile components. This assures that no change in conductivity and composition occurs due to the volatilisation of some compounds contained therein. Thus, the conductivity is kept constant. The polymeric electrolytes disclosed in the document include a polar polymer matrix, a dissociable salt, and a plasticizer of polyether or polyester oligomers having terminal halogenated groups.

U.S Pat. No. 5,776,796 describes a battery having a solid polymer electrolyte, an anode and a cathode which are passivation free. The anode consists of Li₄T₅O₁₂. The electrolyte comprises a polymer host such as poly(acrylonitrile), poly(vinyl chloride), poly(vinyl sulphone) and poly(vinylidene fluoride), plasticized by a solution of a Li salt in an organic solvent. The cathode includes LiMn₂O₄, LiCoO₂, LiNiO₂ and LiV2O₅, and derivatives thereof. The decrease of the passivating layer is achieved by the choice of the electrode and the electrolyte material. The passivating film in the lithium battery utilising poly(acrylonitrile) based electrolytes could be eliminated by using an electrode which intercalated Li at a potential higher than 1 V versus Li+/Li. It is the choice of the anode material in combination with a poly(acrylonitrile) based electrolyte which provides the passivation free surface.

WO-A1-9706207 describes a polymer electrolyte that can be produced as a thin film. The polymer electrolyte is made by polymerising a thin layer of a solution containing three monomers, an electrolyte salt and a plasticizer. One of the monomers is a compound having two acryloyl functionalities, another is a compound having one acryloyl or allyl functionality and also contains groups having high polarity such as a carbonate or a cyano group. Another selected monomer is a compound having one acryloyl functionality and an oligo/oxyethylene)group (—CH₂CH₂—O). This result in an electrolyte film formed without phase separation and is said to show good mechanical properties and high ionic conductivity at ambient temperatures.

There are at present no known solutions to the problem with compatibility between the surface of the anode and the gel electrolyte. One way to decrease the problem is to use polymer electrolytes, which lack plasticizers. However, this leads to that the conductivity at ambient temperature will be insufficient.

The growth of the passivating layer is described in the literature in several ways. One suggested process is that a first inorganic passivating layer is formed on the surface of the electrode after a first discharge of the battery. This layer is a stabilising layer from the electrochemical point of view. After this, a second organic layer is formed by reactions with the solvent, and other species in the electrolyte. This layer increases in thickness during the cycling of the battery and the capacity decreases correspondingly. The layer is probably not evenly distributed on the contact surface between the electrode and the polymer electrolyte, thus forming areas having varying thickness. These differences may result in instability at high temperatures because of formation of two gas pockets”. The presence of this passivating layer is the main problem with the application of polymer gel electrolytes in lithium polymer batteries. The composition of the layer formed on the interface between electrode and electrolyte depends on the type of electrolyte. For example, the layer on a lithium surface in γ-butyro lactone with LiBF₄ consists mainly of lithium butylate and LiF, as shown by Aurbach et al. (Electrochem. Soc., 136, 1606 (1989)). The layer on the lithium surface in carbonate solvents, such as ethylene carbonate and propylene carbonate, consists of the corresponding ROLi, ROCO₂Li, LiF, and Li₂CO₃.

These differences in composition affect the internal resistance and polarization of the cells. The process and kinetics of film formation at the interface between electrode and gel electrolyte and the compositions of the film are still not clear.

The problems mentioned above are solved by the invention and the object of the present invention is to provide a polymer electrolyte having a decreased passivating layer, which leads to an improved efficiency and a longer battery life time.

### SUMMARY OF THE INVENTION

The polymer gel electrolyte according to the invention works as a mechanical and a dimensional stable network, and at the same time it provides a stabilising effect against the electrode surface.

According to the invention, this is achieved by a polymer gel electrolyte comprising a metal salt, a polymer, and optionally a plasticizer, wherein the polymer comprises a polymer backbone having reactive side chains provided with different reactivity incorporated, called “reactive sites”, which “reactive sites” can react with the impurities formed. This reduces the problem regarding non-favourable reactions at the electrode surface. Also impurities from the metal salt can react with the solvent, possibly contributing to solvent instability and non-favourable transport rates of ions. Impurities can for instance be different types of radicals, which are very reactive, hydrogen fluoride, and anions from the solvents depending on the composition of the electrolyte solution.

Preferably, the reactive sites are double bonds incorporated in the polymer. Double bonds are used when cross-linking the polymer, whereby the double bonds are irradiated with light, preferably UV light. The crosslinked polymer can be produced by using a double bond, incorporating for example allyl groups, by the use of allyl methacrylate as a comonomer during polymerization. There are no specific limitation on the chemical compound that can be applied according to the invention for introducing crosslinks, and any compound capable of undergoing chemical reaction such as thermal polymerization or active light polymerization (photopolymerization) to produce crosslinks can be employed.

According to a preferred embodiment of the invention, the polymer gel electrolyte comprises a metal salt, a polymer, optionally a plasticizer, wherein the polymer comprises a carbon-hydrogen base chain having at least two reactive groups incorporated, wherein the reactive groups have different reactivities.

At least one of the reactive groups comprises double bonds. Preferably, two reactive groups are groups comprising double bonds. These groups are preferably allyl and crotyl groups.

At least one of the reactive groups may comprise halogens such as Cl and/or epoxides.

According to a preferred embodiment of the invention, the polymer has the following structure:

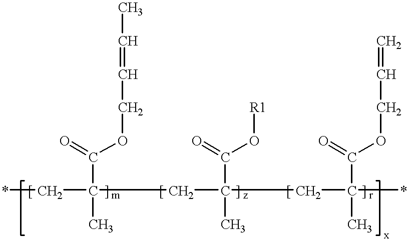

wherein:

m, z, and r, are up to 15 wt-%, above 75 wt-%, and up to 10 wt-%, respectively, and R1 can be an alky, alkyl, fluorinated alkyl, arryl, alkyl containing ethylene and/or propylene oxide, possibly provided with a halogen.

The present invention solves the problem of neutralising impurities, formed in the electrolyte phase. In light of the foregoing, another object of the present invention is to provide a polymer for use in battery cells for rechargeable batteries.

Other preferred characteristic features of the invention and further embodiments thereof will be apparent from the following dependent claims.

### BRIEF DESCRIPTION OF THE DRAWINGS

The present invention will now be described in more detail with reference to the accompanying drawing figures, in which:

FIG. 1 is a schematic representation of a polymer provided with reactive groups.

FIG. 2 illustrates the reaction mechanism of a polymer provided with reactive groups reacting with a waste product such as hydrogen fluoride.

FIG. 3 shows a cyclic voltamogram from Example 2.

### DETAILED DESCRIPTION OF EMBODIMENTS

FIG. 1 shows a polymer generally referenced 1. The polymer comprises reactive groups 2a-b incorporated. The reactive groups 2a-b are double bonds, but may be any other kind of reactive group well known to a person skilled in the art. The reactive groups are of at least two different types, wherein the reactive groups have different reactivites. Other reactive groups that may be incorporated are epoxides, and halogen substituted molecules.

R1 can be an alkyl, arryl, fluorinated alkyl, arryl, alkyl containing ethylene and/or propylene oxide, possibly provided with a halogen.

The manner in which the polymer is produced is not significant to the present field of use. Thus, the polymer may be produced in any suitable way, for instance by producing a polymer having double bonds in excess, which is irradiated with UV-light. The intensity and/or duration of the irradiation is optimised to save some of the double bonds, which can act as reactive groups. For instance, in the illustrated polymer in

FIG. 1, allylmethacrylate 2b is more reactive than crotylmethacrylate 2a. This means that double bonds in the allyl groups react before the crotyl groups. By applying an appropriate dose of UV radiation (time and intensity), the number of double bonds and reaction ratio, can be optimized to produce a reactive polymer gel electrolyte membrane.

In the case when allyl and crotyl groups are used, the allyl groups are mainly used for crosslinking the polymer. The crotyl groups will have their double bonds remaining to react with impurities.

Since the crotyl groups do not react as fast and easy as the allyl groups do, they will not crosslink the polymer during the polymerisation. A polymer with only one kind of reactive group will not work as good as a polymer with at least two groups having different reactivites. The groups with higher reactivity will be used for crosslinking the polymer and the group with lower reactivity will be remaining and able to react with the impurities.

If only groups with high reactivity would be used, there is a risk that all of the double bonds would react during the polymerisation process. Thus, no double bonds would be left. On the other hand, if only groups with low reactivity would be used, there is a risk that the polymer would not cross-link. These problems have been solved by the invention by using groups with different reactivities.

Different types of impurities can be present and produced in a lithium polymer battery. They can roughly be divided into i) protic species, ii) anionic species from solvents and iii) radical species.

### Protic Species

Protic species such as water, are difficult to analyze in low concentrations, but are known to have a significant influence when operating a lithium battery system (Y. Ein-Eli, B. Markowski, D. Aurbach, Y. Canneli, H. Yamin, S. Luski, Electrochim. Acta 39 (1994) 2559). In electrolytes, containing for example LiPF₆ as the electrolytic lithium salt, water has a very negative influence in the performance of secondary lithium batteries. Directly related to the water is the content of HF in the LiPF₆-based electrolytes which has to be controlled carefully. Other protic species such as alcohols are also important as regards the electrolyte quality.

The majority of protic species are formed through the reaction with water, e.g., poly carbonate (PC)+H₂O→propylene glycol+CO₂. It has been shown by U. Heider et al. (Journal of Power Sources 81-82 (1999) 119-122) that a decreasing H₂O content in the electrolyte is directly related to the reaction with the lithium salt, when using LiPF₆. It is not known which acids, besides HF, that are formed and it is difficult to identify other species. LiPF₆ decomposes in the presence of water as follows;

LiPF₆+HO₂→2HF+POF₃+LiF

A similar reaction can occur if either methanol or ethanol is the protic species. The kinetics of the reaction is more rapid for ethanol than for methanol. The resulting HF and other acidic species are known to be corrosive to the cathode materials, for example lithium manganese spinel, and the solid electrolyte interfaces (SEI) of the electrodes. In some cases, reaction products can be gaseous, which results in a pressure increase in the battery. Aurbach et al. (J. Electrochem. Soc. 143 (1996) 3809) have presented the following reactions of HF with the solid electrolyte interface:

Li₂CO₃+2HF→2LiF+H₂CO₃

(CH₂OCO₂Li)₂+2HF→(CH₂OH)₂+2LiF+2CO₂

These reactions lead to a rapid capacity loss and poor cycle life of a lithium battery.

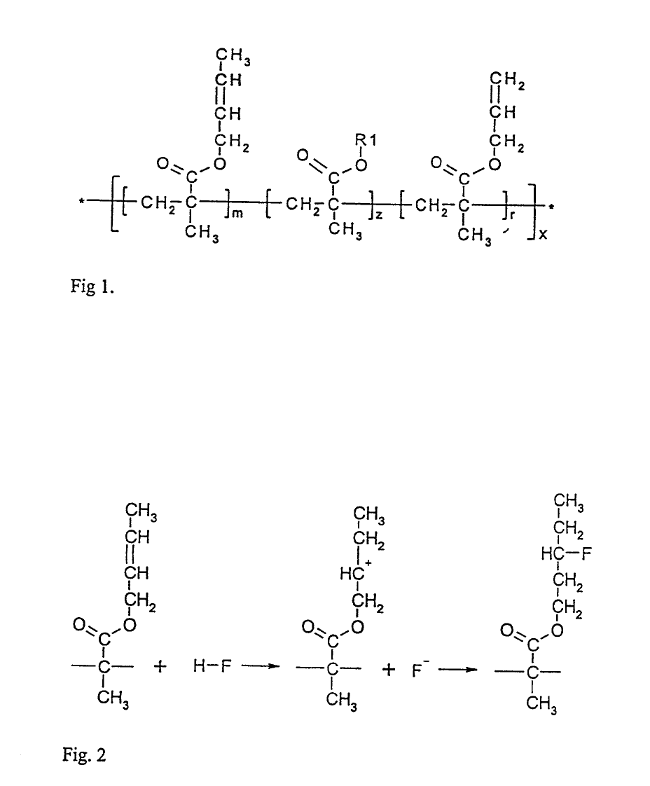

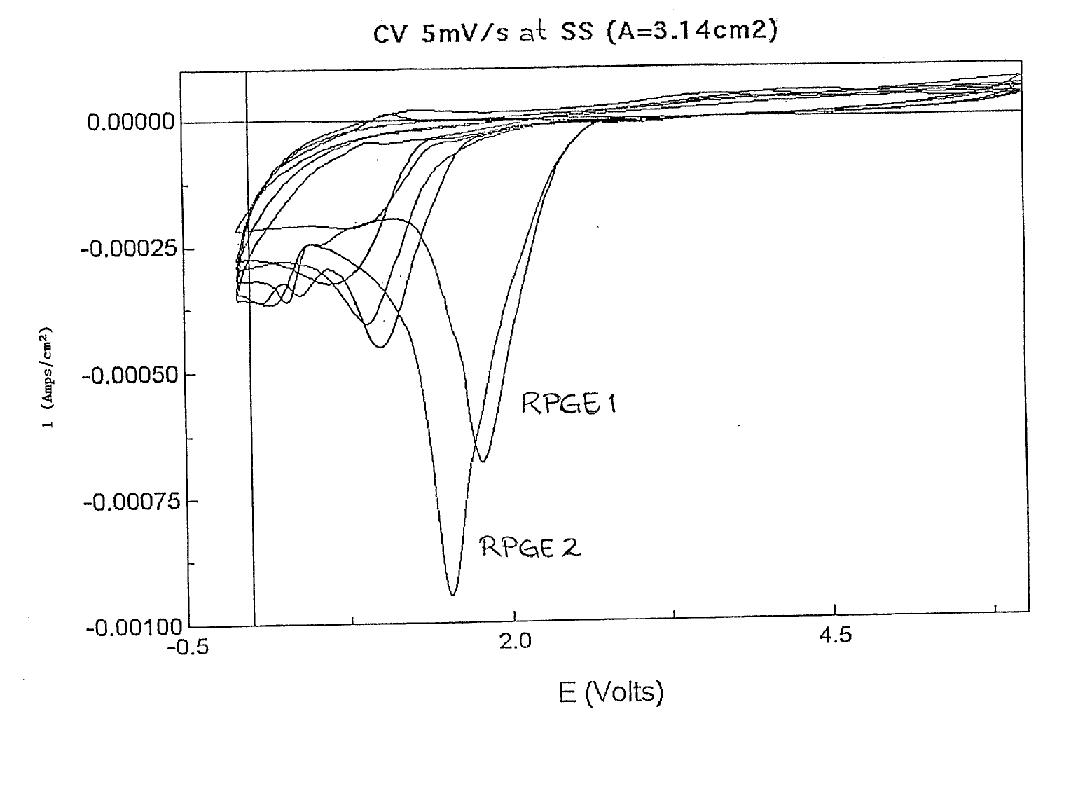

The polymer electrolyte according to present invention is capable of neutralising species such as HF, and the function of the reactive groups 2a is further illustrated in FIG. 2 in a reaction mechanism, showing the reaction steps.

### Anionic Species

Examples of anionic species commonly formed when operating lithium polymer battery cells are different types of carbonate species. They are frequently represented when ethylene carbonate and/or propylene carbonate are used as electrolyte solvents, and consists of the corresponding ROLi, ROCO₂Li, and Li₂CO₃. (D. Aurbach, B. Markovsky, A. Shechter, and Y Ein-Eli, Electrochem. Soc. 143, 3809(1996)). Anionic species can form oligomers on the electrode surfaces. These organic species are not evenly distributed on the electrode surfaces, but are thought to form domains of varying thickness. These domains are commonly regarded as parts of the second passivation layer formed during cycling of the lithium polymer battery. Example of reactive groups that can neutralise these types of anionic species before they react at the electrode surface are groups substituted with halogens. They react with anionic species through a SN2 mechanism:

RO—Li++R1CH₂Cl→ROCH₂R1+Li+Cl—

Halogen substituted reactive groups can be introduced in the polymer chain by using, for example a SN2 mechanism.

### Radicals

Several types of radicals can be present in such a complex system as polymer gel electrolytes. Especially when radicals are activated by u.v. light in the crosslinking process. Some radicals are more activated than others and are therefore easier to neutralize. Active radicals can be neutralized with, for example, crotyl or allyl groups as presented earlier. The use of, for example, acrylates wherein the reactive double bond has not been transformed during the polymerisation and/or crosslinking of the gel electrolyte, can neutralize the less active radicals. Thus, acrylates with multiple functionalities can be introduced in the polymer chain before the crosslinking process.

A polymer gel electrolyte contains, in addition to the polymer, a solvent (plasticizer) and a salt, which is responsible for electrolytic transport properties of the gel. Many combinations of solvents and salts are possible to use for the polymer gel electrolyte of the invention.

Solvents used for preparation of the gel electrolyte according to the invention can be selected from: ethylene carbonate (EC), propylene carbonate (PC), diethyl carbonate, dimethyl carbonate, methylethyl carbonate, g-butyrolactone, g-butylene carbonate, tetrahydrofuran, 2-methyltetrahydrofuran, dimethyl sulfoxide, 1,2-dimethoxyethane, 1,2-ethoxymethoxyethane, dioxylane, sulfolane, methyl glyme, methyl triglyme, methyl tetraglyme, ethyl glyme, ethyl diglyme, etherified oligomers of ethylene oxide and butyl diglyme, and mixtures of said solvents. Other solvents can be: modified carbonates, and substituted cyclic and non-cyclic esters, preferably methyl-2,2,2-trifluoroethyl carbonate, di(2,2,2-trifluoroethyl) carbonate and methyl-2,2,3,3,3-pentafluoropropyl carbonate.

Many different salts and mixtures of salts can be used for the preparation of the gel electrolyte according to the present invention. As preferred examples are given salts of Lewis acid complexes, such as LiAsF₆, LiPF₆, LiBF₄ and LiSbF₆; and sulfonic acid salts, such as LiCF₃SO₃, LiC(CF₃SO₂) ₃, LiC(CH₃)(CF₃ SO₂)₂, LiCH(CF₃SO₂)₂, LiCH₂(CF₃ SO₂), LiC₂F₅SO₃, LiN(C₂F₅SO₂)₂, LiN(CF₃SO₂)₂, LiB(CF₃SO₂)₂and LiO(CF₃SO₂). The salts for the preparation of the gel electrolyte are not limited to the examples given above. Other conceivable salt types include LiClO₄, LiCF₃CO₃, NaClO₃, NaBF₄, NaSCN, KBF₄, Mg(ClO₄) 2 and Mg(BF₄)₂, as well as any salt being used in conventional electrolytes can be employed. As noted previously, the various salts exemplified above can also be used in combination.

The polymer gel electrolyte according to the present invention is preferably used as electrolyte in batteries, condensers, sensors, electrochromic devices, and semiconductor devices. In general, a battery consists of an anode, prepared from an active, positive electrode material, an electrolyte, and a cathode prepared from an active, negative electrode material. Often it can be advantageous to use a mechanical separator between the anode and the cathode, to prevent accidental contacts between the electrodes, leading to short-circuit. When the gel electrolyte of the invention is crosslinked and applied in a battery, the gel electrolyte itself can function as the mechanical separator in the battery cell. Though the polymer gel electrolyte according to the invention can be used as a membrane in a battery cell, it can be used after a filler is dispersed therein or after it is combined with a porous separator to prepare a mechanically stable composite. Examples of the separators are glass fiber filters; nonwoven fabric filters made of fibers of polymers such as polyester, Teflon, Polyflon, polypropylene and polyethylene; and other nonwoven fabric filters made of mixtures of glass fibers and the above polymeric fibers.

The invention also concerns a polymer battery cell comprising a cathode, an anode and a polymer electrolyte comprising a metal salt, a polymer and possibly at least one plasticizer or solvent, wherein the polymer comprises a carbon-hydrogen based chain having at least two reactive groups incorporated, wherein the reactive groups have different reactivites.

The polymer in the battery cell is the same polymer as described above.

Examples of positive electrode materials used in a battery can be transition metal oxides, such as V₂O₅, MnO₂ and CoO₂; transition metal sulfide, such as TiS₂, MOS₂ and Co₂S₅; transition metal chalcogen compounds; and complex compounds of these metal compounds and Li (i.e. Li complex oxides), such as LiMnO₂, LiMn₂O₄, LiCoO₂, LiNiO₂, LiCoₓNi₁₋ₓO₂(0<x<1), LiMn₂₋ₐXₐO₄ and LiMn_{2-a-b}XₐY_{b}O₄(0<a<2, 0<b<2, 0<a+b<2). Examples of electroconductive materials include one-dimensional graphitization products (thermal polymerization products of organic materials); fluorocarbons; graphites; and electroconductive polymers having an electrical conductivity of not less than 10⁻² S/cm, such as polyaniline, polyimide, polypyrrole, polypyridine, polyphenylene, polyacetylene, polyazulene, polyphthalocyanine, poly-3-methylthiophene, and polydiphenylbenzidine, and derivatives of these conductive polymers.

Examples of negative electrode active materials in a battery can be metallic materials, such as lithium, lithium-aluminium alloy, lithium-tin alloy and lithium-magnesium alloy; carbons (including graphite type and non-graphite type); carbon-boron substituted substances (BC2N); and intercalation materials capable of occluding lithium ion, such as tin oxide. Particular examples of the carbons include calcined graphites calcined pitch, calcined coke, calcined synthetic polymers and calcined natural polymers. Examples of positive current collectors for use in the invention include metal sheets, metal foils, metal nets, punching metals, expanded metals, metal plated fibers, metallized wires, and nets or nonwoven fabrics made of metal containing synthetic fibers. Examples of metals used for these positive current collectors include stainless steel, gold, platinum, nickel, aluminum, molybdenum and titanium.

The anode, the cathode and the electrolyte layer are assembled to form a battery.

The battery is assembled by providing the anode. The electrolyte layer is positioned over the anode. The cathode is positioned over the electrolyte layer to form the assembly. Pressure is applied to the assembly. Pressure may be as minimal as merely pressing the layers together by hand or by applying pressure in a press. The amount of pressure is sufficient to allow for intimate contact to be obtained between the layers. In an additional step to the process, the assembly is subjected to a higher temperature wherein the contact between the different layers is improved. The assembly is then allowed to cool to room temperature. Finally, the assembly is enclosed in a protective casting and charged under constant voltage or constant current.

Further, the invention refers to the use of a polymer battery cell in portable communication equipment, such as cellular phones, personal pagers, portable computers and other electrical devices, such as smart cards and calculators.

The invention will now be described in more detail with reference to two examples.

### EXAMPLE 1

### Preparation of Polymer

The graft copolymers were synthesized by radical polymerisation techniques using a macromonomer together with comonomers. The graft copolymers were synthesized using azobisisobutyronitrile (AIBN) as a radical initiator. To a three-necked flask, equipped with a stirrer, 9.2 g of poly(ethylene glycol) (Mn=88) monomethyl ether methacrylate, 0.5 g of allyl methacrylate, and 1.1 g of crotyl methacrylate were added to 100 ml of toluene. After the reaction mixture had been subjected to N₂ to ensure oxygen free environment, 0.13 g of AIBN was added to the three-necked flask. The radical copolymerisations were carried out at a temperature of 60° C. under N₂ for a time of around 7 h. After the synthesis the reaction mixture was filtrated to remove gel particles before removing residual monomers. The graft copolymer was first precipitated in methanol, and after drying, the precipitates were dissolved in tetrahydrofurane (THF). The second precipitation was performed in n-hexane, to remove the monomers, and then dried. Finally, the purity of the graft copolymers was checked with GPC by following the disappearance of PEO monomers.

From NMR analysis it was shown that the synthesized amphiphilic graft copolymer, used in the examples, consisted of 90 percent by weight of poly(ethylene glycol) (Mn=400) monomethyl ether methacrylate, 5 percent by weight of allyl methacrylate and 5 percent by weight of crotyl methacrylate.

### Preparation of Polymer Gel Electrolyte Membrane

In anhydrous γ-butyro lactone was LiPF₆ dissolved to give a solution containing 1.0 mole per liter. In this electrolyte solution the amphiphilic graft copolymer was dissolved in an amount of 30 percent by weight to give a homogenous polymer gel electrolyte. Then a photo activator was added and the polymer gel electrolyte was film cast on a plate before being exposed to u.v. radiation. The resulting crossliked polymer gel electrolyte had an improved mechanical stability, as compared to the dissolved polymer gel electrolyte.

### EXAMPLE2

A polymer was prepared in the same way as in Example 1, but with different contents. Two polymers were prepared. RPGE1 consisted of 85 percent by weight of poly(ethylene glycol)(Mn=400) monomethyl ether methacrylate, 5 percent by weight of allyl methacrylate and 10 percent by weight of crotyl methacrylate.

RPGE2 consisted of 95 percent by weight of poly(ethylene glycol) (Mn=400) monomethyl ether methacrylate and 5 percent by weight of allyl methacrylate. The samples RPGE1 and RPGE2 were prepared and doped in order to increase the amount of hydrogen fluoride.

Protic impurities, such as alcohols, are mainly formed by reaction between the solvent and water, for example in a battery cell. LiPF₆ reacts with protic impurities, such as glycol, which leads to the formation of hydrogen fluoride, as shown by Heider et al. (Journal of Power Sources 81-82 (1999) 119-122). Therefore, the gels were crosslinked by UV-radiation and doped with glycol before the samples were investigated by voltammetry. The amount of glycol added in both RPGE1 and RPGE2 was approximately 1.5 wt % of the total polymer gel electrolyte weight.

FIG. 3 shows cyclic voltammograms of the two gels and it can be seen that the reduction of protonic species is less salient for RPGE1, which contains crotyl groups, compared to the reduction of protonic species for RPGE2. The curves marked with RPGE1 and RPGE2 are the curves for the first cycles of the two materials. The smaller “peak” close to 2,0 Volts for RPGE1, indicates a lesser degree of reduction of protons. This shows that there are less protons in RPGE1 which contains crotyls as compared to RPGE2. Thus, RPGE1 has neutralised hydrogen fluoride to a higher degree.

The invention shall not therefore be considered limited to the afore described exemplifying embodiments thereof, since other embodiments are conceivable within the scope of the following claims.

1. A polymer gel electrolyte comprising a metal salt, a polymer, optionally a plasticizer, characterised in that the polymer comprises a carbon-hydrogen base chain having at least two reactive groups incorporated, wherein the reactive groups have different reactivities.

2. A polymer gel electrolyte according to claim 1, characterised in that at least one of the reactive groups comprises double bonds.

3. A polymer gel electrolyte according to claim 1 or 2, characterised in that two reactive groups comprises double bonds.

4. A polymer gel electrolyte according to claim 3, characterised in that the reactive groups are allyl and crotyl groups.

5. A polymer gel electrolyte according to claim 1 or 2, characterised in that at least one of the reactive groups is a group comprising halogens, such as C1 and/or epoxides.

6. A polymer gel electrolyte according to any one of the claims 1-5, characterised in that the polymer has the following structure: 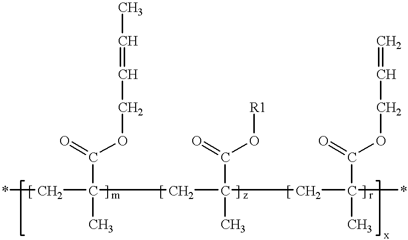
wherein:
m, z, and r, are up to 15 wt-%, above 75 wt-%, and up to 10 wt-%, respectively, and R1 can be an alkyl, arryl, fluorinated alkyl, arryl, alkyl containing ethylene and/or propylene oxide, possibly provided with a halogen.

7. A polymer gel electrolyte according to any one of the preceding claims, characterised in that the metal salt is selected from a group consisting of salts of Lewis acid complexes, such as LiAsF₆, LiPF₆, LiBF₄ and LiSbF₆; and sulfonic acid salts, such as LiCF₃SO₃, LiC(CF₃SO₂)₃, LiC(CH₃)(CF₃SO₂)₂, LiCH(CF₃SO₂)₂, LiCH₂(CF₃SO₂), LiC₂F₅SO₃, LiN(C₂F₅SO₂)₂, LiN(CF₃SO₂)₂, LiB(CF₃SO₂)₂ and LiO(CF₃SO₂).

8. A polymer gel electrolyte according to any one of the preceding claims, characterised in that said metal salt is selected from a group consisting of salts of LiClO₄, LiCF₃CO₃, NaClO₃, NaBF₄, NaSCN, KBF₄, Mg(ClO₄)₂ and Mg(BF₄)₂.

9. Use of a polymer gel electrolyte according to any one of the claims 1-8, as electrolyte in batteries, condensers, sensors, electrochromic devices, and semiconductor devices.

10. A polymer battery cell comprising a cathode, an anode, and a polymer electrolyte comprising a metal salt, a polymer and possibly at least one plasticizer or solvent, characterised in that the polymer comprises a carbon-hydrogen base chain having at least two reactive groups incorporated, wherein the reactive groups have different reactivities.

11. A polymer battery cell according to claim 10, characterised in that at least one of the reactive groups comprises double bonds.

12. A polymer battery cell according to claim 10 or 11, characterised in that two reactive groups comprises double bonds.

13. A polymer battery cell according to claim 12, characterised in that the reactive gropus are allyl and crotyl groups.

14. A polymer battery cell according to claim 10 or 11, characterised in that at least one of the reactive groups is a group comprising halogens, such as C1 and/or epoxides.

15. A polymer battery cell according to any one of the claims 10-14, characterised in that the polymer has the following structure: 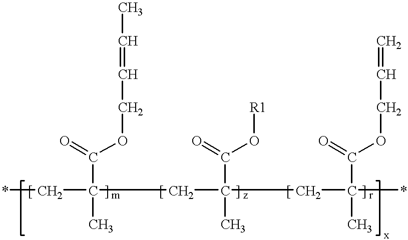
wherein:
m, z, and r, are up to 15 wt-%, above 75 wt-%, and up to 10 wt-%, respectively, and R1 can be a R1 can be an alky, arryl, fluorinated alkyl, arryl, alkyl containing ethylene and/or propylene oxide, possibly provided with a halogen.

16. A polymer battery cell according to any one of the claims 10-15, characterised in that the metal salt is selected from a group consisting of salts of Lewis acid complexes, such as LiAsF₆, LiPF₆, LiBF₄ and LiSbF₆; and sulfonic acid salts, such as LiCF₃SO₃, LiC(CF₃SO₂)₃, LiC(CH₃)(CF₃SO₂)₂, LiCH(CF₃SO₂)₂, LiCH₂(CF₃SO₂), LiC₂F₅SO₃, LiN(C₂F₅SO₂) ₂, LiN(CF₃SO₂)₂, LiB(CF₃SO₂)₂ and LiO(CF₃SO₂).

17. A polymer battery cell according to any one of the claims 10-16, characterised in that said metal salt is selected from a group consisting of salts of LiClO₄, LiCF₃CO₃, NaClO₃, NaBF₄, NaSCN, KBF₄, Mg(ClO₄)₂ and Mg(BF₄)₂.

18. Use of a polymer battery cell according to any one of the claims 10-17, in portable communication equipment, such as cellular phones, personal pagers, portable computers and other electrical devices, such as smart cards, and calculators.
